(19) United States
(12) Patent Application Publication
(10) Pub. No.: US 2026/0279077 A1
(43) Pub. Date: Sep. 17, 2026

(54) ELECTRONIC DEVICE AND METHOD OF OPERATING THE SAME

(71) Applicant: SAMSUNG ELECTRONICS CO., LTD., Suwon-si (KR)

(72) Inventors: Kyoungjae PARK, Suwon-si (KR); Cheulhee HAHM, Suwon-si (KR); Sangyoung LEE, Suwon-si (KR)

(73) Assignee: SAMSUNG ELECTRONICS CO., LTD., Suwon-si (KR)

(21) Appl. No.: 19/676,438

(22) Filed: May 13, 2026

Related U.S. Application Data
(63) Continuation of application No. PCT/KR2026/000185, filed on Jan. 5, 2026.

(30) Foreign Application Priority Data
Jan. 3, 2025 (KR) 10-2025-0001169

(51) Int. Cl. G06V 20/62; G06V 10/44; G06V 10/56; G06V 10/62; G06V 10/77; G06V 10/82

(52) U.S. Cl. CPC G06V 20/62; G06V 10/454; G06V 10/56; G06V 10/62; G06V 10/7715; G06V 10/82

(57) ABSTRACT

An electronic device obtains, based on a neural network, a feature corresponding to an object from at least one frame among frames corresponding to content, detects the object from another frame of the content based on the obtained feature corresponding to the object, and performs an image processing on the object or an image surrounding the object such that the object is distinguished in another frame in which the object is obtained.

### CROSS-REFERENCE TO RELATED APPLICATION

This application is a continuation application, under 35 U.S.C. §111(a), of international application No. PCT/KR2026/000185, filed January 5, 2026, which claims priority under 35 U. S. C. §119 to Korean Patent Application No. 10-2025-0001169, filed January 3, 2025, the disclosures of which are incorporated herein by reference in their entireties.

### TECHNICAL FIELD

Various embodiments of the disclosure relate to an electronic device and a method of operating the same, and more particularly, to an electronic device capable of improving visibility of a subtitle, and a method of operating the same.

### BACKGROUND ART

A significant portion of content viewable on multimedia devices includes subtitled video. Recent diversification of content has led to a significant increase in foreign content from multiple countries. Because video and subtitles are input separately for content from broadcast channels or over-the-top (OTT) applications, users may view the content with subtitles customized in terms of size, color, font, position, and the like. In addition, for content with separately input video and subtitles, functions are provided that enable viewing with subtitle positions automatically adjusted according to the video. However, subtitles for video available through movie channels or foreign channels are pre-generated by broadcasters and embedded in the video. Because these subtitles cannot be separately adjusted by users, situations frequently arise where subtitles are invisible due to similarity with the background color, or where subtitles are difficult to read due to overlapping with other text.

### DISCLOSURE

### Technical Solution

According to an embodiment of the disclosure, an electronic device may include a memory including one or more instructions, and at least one processor. According to an embodiment of the disclosure, the at least one processor may individually or collectively execute the one or more instructions to cause the electronic device to obtain, based on a neural network, a feature corresponding to an object from at least one frame among frames corresponding to content. According to an embodiment of the disclosure, the at least one processor may individually or collectively execute the one or more instructions to cause the electronic device to detect, based on the obtained feature corresponding to the object, the object in another frame among the frames corresponding to content other than the at least one frame from which the feature corresponding to the object is obtained. According to an embodiment of the disclosure, the at least one processor may individually or collectively execute the one or more instructions to cause the electronic device to perform an image processing on the object or an image surrounding the object such that the object is distinguished in the other frame in which the object is obtained.

According to an embodiment of the disclosure, a method of operating an electronic device may include obtaining, based on a neural network, a feature corresponding to an object from at least one frame among frames corresponding to content. According to an embodiment of the disclosure, the method of operating the electronic device may include detecting, based on the obtained feature corresponding to the object, the object in another frame among the frames corresponding to content other than the at least one frame from which the feature corresponding to the object is obtained. According to an embodiment of the disclosure, the method of operating the electronic device may include performing an image processing on the object or an image surrounding the object such that the object is distinguished in the other frame in which the object is obtained.

According to an embodiment of the disclosure, in a non-transitory computer-readable recording medium having stored therein one or more instructions executable by at least one processor of an electronic device, the one or more instructions, when executed by the at least one processor of the electronic device, may cause the electronic device to obtain, based on a neural network, a feature corresponding to an object from at least one frame among frames corresponding to content, detect, based on the obtained feature corresponding to the object, the object in another frame among the frames corresponding to content other than the at least one frame from which the feature corresponding to the object is obtained, and perform an image processing on the object or an image surrounding the object such that the object is distinguished in the other frame in which the object is obtained.

### DESCRIPTION OF DRAWINGS

The disclosure may be readily understood with a combination of the following detailed description and the accompanying drawings, wherein reference numbers refer to structural elements.

FIG. 1 is a reference diagram for describing a concept of a method of detecting a subtitle, according to an embodiment of the disclosure.

FIG. 2 illustrates an example of a system according to an embodiment of the disclosure.

FIG. 3 illustrates an example of a system including an electronic device, a content providing server, and a service server, according to an embodiment of the disclosure.

FIG. 4 is an example of a block diagram of an electronic device according to an embodiment of the disclosure.

FIG. 5 illustrates an example of an object processing module according to an embodiment of the disclosure.

FIG. 6 illustrates an example of a deep neural network (DNN) model according to an embodiment of the disclosure.

FIG. 7 illustrates an example of a method of operating an electronic device, according to an embodiment of the disclosure.

FIG. 8 is a flowchart illustrating processes of a method of operating an electronic device, according to an embodiment of the disclosure.

FIG. 9 illustrates examples of images including subtitles, according to an embodiment of the disclosure.

FIG. 10 is a reference diagram for describing an example of detecting a subtitle in an image including the subtitle, according to an embodiment of the disclosure.

FIG. 11 is a reference diagram for describing an example of rendering other characters in an image surrounding a subtitle invisible by using an in-painting technique, according to an embodiment of the disclosure.

FIG. 12 is a flowchart illustrating processes of a method of operating an electronic device, according to an embodiment of the disclosure.

FIG. 13 is a reference diagram for describing an operation performed when content is changed, according to an embodiment of the disclosure.

FIG. 14 is a flowchart illustrating processes of a method of operating an electronic device, according to an embodiment of the disclosure.

FIG. 15 is a reference diagram for describing an operation performed when content is changed, according to an embodiment of the disclosure.

FIG. 16 is a flowchart illustrating processes of a method of operating an electronic device, according to an embodiment of the disclosure.

FIG. 17 is a reference diagram for describing an operation performed when content is not changed, according to an embodiment of the disclosure.

FIG. 18 is a flowchart illustrating processes of a method of operating an electronic device, according to an embodiment of the disclosure.

### DESCRIPTION

### Mode for Invention

The terms used herein will be briefly described, and then the disclosure will be described in detail.

Although the terms used herein are selected from among common terms that are currently widely used in consideration of their functions in the disclosure, the terms may be different according to an intention of one of ordinary skill in the art, a precedent, or the advent of new technology. Also, in particular cases, the terms are discretionally selected by the applicant of the disclosure, in which case, the meaning of those terms will be described in detail in the corresponding part of the detailed description. Therefore, the terms used herein are not merely designations of the terms, but the terms are defined based on the meaning of the terms and content throughout the disclosure.

Throughout the specification, when a part "includes" a component, it means that the part may additionally include other components rather than excluding other components as long as there is no particular opposing recitation. In addition, as used herein, the terms such as "...er", "... unit", "... module", etc., denote a unit that performs at least one function or operation, which may be implemented as hardware or software or a combination thereof.

Hereinafter, embodiments of the disclosure will be described with reference to the accompanying drawings in such a manner that the embodiments may be easily carried out by those of skill in the art. The disclosure may, however, be embodied in many different forms and should not be construed as being limited to an embodiment set forth herein. In order to clearly describe the disclosure, portions that are not relevant to the description of the disclosure are omitted in the drawings, and similar reference numerals are assigned to similar elements throughout the specification.

As used herein, the term "user" refers to a person who controls functions or operations of a computing device or an electronic device by using a control device, and may include a viewer, an administrator, or an installer. In the disclosure, a user of an electronic device providing a broadcast may be referred to as a gamer, a player, a streamer, or the like, while a user of a device viewing the broadcast may be referred to as a viewer or the like.

An artificial intelligence system is a computer system that implements human-level intelligence, in which a machine learns and makes judgments autonomously, and accuracy improves as the system is used. Artificial intelligence technology includes machine learning (deep learning) technology using an algorithm that classifies or learns features of input data autonomously, and element technologies that mimic functions of a human brain, such as cognition and judgment, by using a machine learning algorithm. The element technologies may include, for example, at least one of language understanding technology for recognizing human languages/characters, visual understanding technology for recognizing objects like human vision, inference/prediction technology for determining information and performing logical inference and prediction, knowledge representation technology for processing human experience information to knowledge data, or motion control technology for controlling autonomous driving of vehicles or the motion of robots.

Functions associated with artificial intelligence according to the disclosure are performed via a processor and memory. The processor may include one or more processors. In this case, the one or more processors may include a general-purpose processor, such as a central processing unit (CPU), an application processor (AP), or a digital signal processor (DSP), a dedicated graphics processor such as a graphics processing unit (GPU) or a vision processing unit (VPU), or a dedicated artificial intelligence processor such as a neural processing unit (NPU). The one or more processors perform control to process input data according to predefined operation rules or an artificial intelligence model stored in the memory. Alternatively, in a case in which the one or more processors are dedicated artificial intelligence processors, the dedicated artificial intelligence processor may be designed with a hardware structure specialized for processing a particular artificial intelligence model.

The predefined operation rules or artificial intelligence model is generated via a training process. Here, being generated via a training process may mean that predefined operation rules or artificial intelligence model set to perform desired characteristics (or purposes), is generated by training a basic artificial intelligence model by using a learning algorithm that utilizes a large amount of training data. The training process may be performed by a device itself on which artificial intelligence according to the disclosure is performed, or by a separate server and/or system. Examples of learning algorithms may include, for example, supervised learning, unsupervised learning, semi-supervised learning, and reinforcement learning, but are not limited thereto.

The artificial intelligence model may include a plurality of neural network layers. Each of the neural network layers has a plurality of weight values, and performs a neural network arithmetic operation via an arithmetic operation between an arithmetic operation result of a previous layer and the plurality of weight values. The plurality of weight values in each of the plurality of neural network layers may be optimized as a result of training the artificial intelligence model. For example, the plurality of weight values may be updated to reduce or minimize a loss or cost value obtained by the artificial intelligence model during a training process. The artificial neural network may include, for example, a deep neural network (DNN) and may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), deep Q-networks (DQN), or the like, but is not limited thereto.

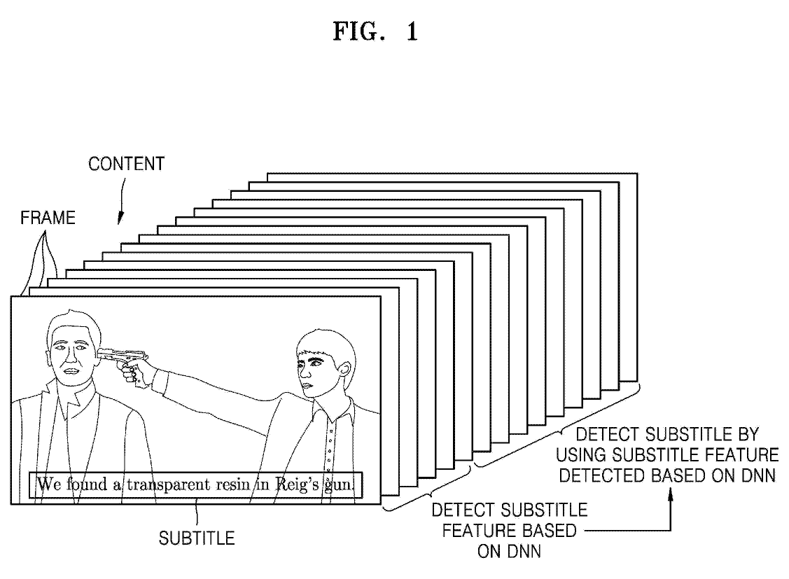

FIG. 1 is a reference diagram for describing a concept of a method of detecting a subtitle, according to an embodiment of the disclosure.

Referring to FIG. 1, content may include a plurality of frames. Frames of video content may represent individual still images constituting the video. A playback device may output a moving image by playing back a plurality of frames rapidly in succession.

A frame may include a subtitle. The position of subtitles in frames is not fixed and may vary across different content. For example, subtitles may be arranged in various ways for each content, such that a subtitle may be arranged at a lower center portion of the frame in certain content, and a subtitle may be arranged at an upper right portion of the frame in other content. For example, FIG. 1 illustrates that a subtitle is arranged at a lower center portion of a frame.

When a frame includes a subtitle, it is advantageous to display the subtitle such that it is distinguished from the frame image, thereby enabling the viewer to easily recognize the subtitle. There may be cases where subtitles are difficult to distinguish in a frame, such as when other text overlaps the position where subtitles are arranged, or when the color of the region of the position where subtitles are arranged is difficult to distinguish from the color of the subtitles. To solve this issue, it is desirable to detect a subtitle in a frame, and perform image processing on the subtitle itself or perform image processing on a background part where the subtitle is located, such that the subtitle is clearly distinguished from the background part where the subtitle is located.

Utilizing a DNN for detecting a subtitle in a frame and performing image processing to enhance visibility of the subtitle may yield favorable results. However, applying a DNN to all frames of content consumes significant processing time and resources, which may render the use of the DNN ineffective on a user device with limited resources. Accordingly, embodiments of the disclosure propose a method for effectively detecting and performing image processing on a subtitle of content in a user device having limited resources.

According to an embodiment of the disclosure, an electronic device may detect a feature of an object from at least some frames of content, based on a DNN.

According to an embodiment of the disclosure, the electronic device may detect the object in a frame of the content by using the detected feature of the object.

According to an embodiment of the disclosure, the electronic device may perform image processing on the object or an image surrounding the object such that the object is distinguished in other frames.

As described above, the electronic device uses a DNN for some frames of the content to detect the feature of the object to be used for detection of the object, without needing to use the DNN across all frames of the content, and thus, resources of the electronic device may be saved or object detection may be effectively performed even in an electronic device lacking resources.

According to an embodiment of the disclosure, the feature of the object may include at least one of a position of the object or a color of the object.

According to an embodiment of the disclosure, the electronic device may determine that the feature of the object is changed, and based on the determination, newly obtain the feature of the object by using the DNN.

According to an embodiment of the disclosure, when a time period during which the object is not detected is greater than a threshold time period or when it is determined, based on program identification information, that the content has changed, the electronic device may determine that the feature of the object is changed.

According to an embodiment of the disclosure, the electronic device may extract the object based on the detected feature of the object, detect one or more detailed features of the object by analyzing the extracted object, and perform image processing on the object or an image of a region surrounding the object, based on the one or more detailed features of the object.

According to an embodiment of the disclosure, the electronic device may transmit, to a server, a request to detect the feature of the object by using a DNN model, and receive, from the server, information about the detected feature of the object.

According to an embodiment of the disclosure, the one or more detailed features of the object may include at least one of a position of the object, a feature of a starting point of the object, a color of the object, a color of a boundary of the object, a feature of a corner of the object, or a color gradient between the object and the background.

According to an embodiment of the disclosure, the electronic device may detect a boundary of the object by using an edge filter that identifies a variation value between the object and a background region.

According to an embodiment of the disclosure, the electronic device may analyze a background image surrounding the object, and perform image processing on the background image surrounding the object or on the object itself such that the object is distinguished from the background image.

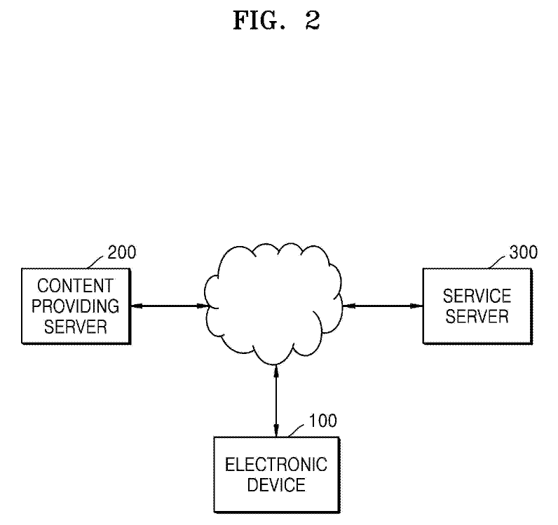

FIG. 2 illustrates an example of a system according to an embodiment of the disclosure.

Referring to FIG. 2, the system may include an electronic device 100, a content providing server 200, and a service server 300.

According to an embodiment of the disclosure, the electronic device 100 may receive and display content from the content providing server 200.

According to an embodiment of the disclosure, when displaying the content, the electronic device 100 may perform image processing to display a particular object included in the content such that the object is better distinguished from an image itself. Objects included in the content may include a subtitle, an advertisement banner, text, a logo, a watermark, and the like.

According to an embodiment of the disclosure, in order to detect an object in the content, the electronic device 100 may first detect a feature of the object from at least some frames included in the content by using a DNN.

According to an embodiment of the disclosure, to obtain the feature of the object included in the content, the electronic device 100 may request the content providing server 200 to transmit the feature of the object, and receive information about the feature of the object from the content providing server 200 in response to the request.

According to an embodiment of the disclosure, to obtain the feature of the object included in the content, the electronic device 100 may request the service server 300 to transmit the feature of the object, and receive information about the feature of the object from the service server 300 in response to the request.

According to an embodiment of the disclosure, in response to a request from the electronic device 100, the content providing server 200 may transmit the content to the electronic device 100.

According to an embodiment of the disclosure, the content providing server 200 may receive from the electronic device 100, a request for transmission of the feature of the object included in the content.

According to an embodiment of the disclosure, in response to the request from the electronic device 100, the content providing server 200 may detect the feature of the object from at least some frames of the content by using a DNN, and transmit the detected feature of the object to the electronic device 100.

According to an embodiment of the disclosure, the service server 300 may receive from the electronic device 100, a request for transmission of the feature of the object included in the content.

According to an embodiment of the disclosure, in response to the request from the electronic device 100, the service server 300 may detect the feature of the object from at least some frames of the content by using a DNN, and transmit the detected feature of the object to the electronic device 100.

Referring to FIG. 2, the electronic device 100 according to an embodiment of the disclosure may be an electronic device capable of receiving content from various sources and displaying the received content. The electronic device 100 may be implemented in various forms, such as a television (TV), a set-top box, a mobile phone, a tablet personal computer (PC), a digital camera, a camcorder, a laptop computer, a desktop, an e-book terminal, a digital broadcasting terminal, a personal digital assistant (PDA), a portable multimedia player (PMP), a navigation device, an MP3 player, or a wearable device.

In addition, the electronic device 100 may be a stationary electronic device arranged at a fixed location or a mobile electronic device having a portable form, or may be a digital broadcast receiver capable of receiving a digital broadcast.

In addition, the electronic device 100 may be controlled by using infrared (IR), Bluetooth (BT), Wi-Fi, or the like via various types of devices such as a remote controller, a mobile phone, or a game pad.

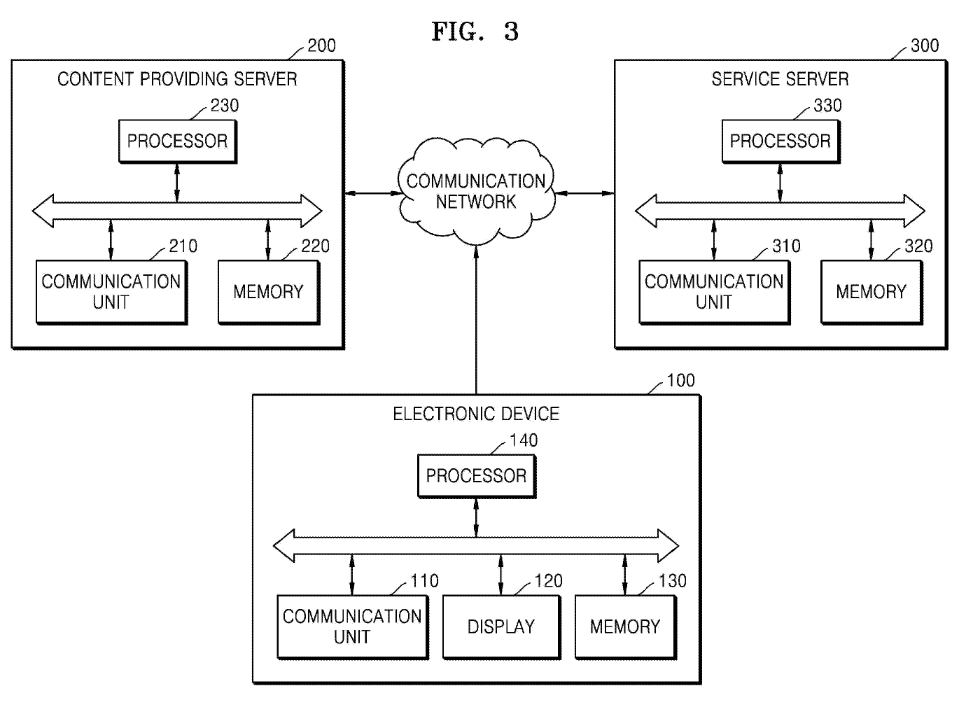

FIG. 3 illustrates an example of a system including an electronic device, a content providing server, and a service server, according to an embodiment of the disclosure.

Referring to FIG. 3, the system may include the electronic device 100, the content providing server 200, and the service server 300 that are connected to each other via a communication network.

The electronic device 100 is a device capable of displaying an image or data according to a request of a user, and may include a communication unit 110, a display 120, memory 130, and a processor 140.

The communication unit 110 may include various pieces of communication circuitry for performing communication with at least one external device. Here, the term 'communication' may refer to an operation of transmitting and/or receiving data, a signal, a request, and/or a command.

The communication unit 110 may perform wired or wireless communication with at least one external device. The external device may include the content providing server 200 or the service server 300.

For example, the communication unit 110 may include at least one of a communication module, communication circuitry, a communication device, an input/output port, or an input/output plug for performing wired or wireless communication with at least one external device.

For example, the communication unit 110 may include at least one wireless communication module, wireless communication circuitry, or wireless communication device that performs wireless communication with at least one external device.

For example, the communication unit 110 may include a short-range communication module, such as an IR communication module, capable of receiving a control command from a remote controller located at a short range, for example, from an input device. In this case, the communication unit 110 may receive a control signal from the remote controller.

As another example, the communication unit 110 may include at least one communication module configured to perform communication according to a wireless communication standard, such as Bluetooth, Wi-Fi, Bluetooth Low Energy (BLE), near-field communication (NFC)/radio-frequency identification (RFID), Wi-Fi Direct, ultra-wideband (UWB), or ZigBee. Alternatively, the communication unit 110 may further include a communication module configured to perform communication with a server for supporting long-range communication according to a long-range communication standard. For example, the communication unit 110 may include a communication module configured to perform communication through a network for Internet communication. In addition, the communication unit 110 may include a communication module configured to perform communication through a communication network complying with a communication standard such as 3^{rd} Generation (3G), 4^{th} Generation (4G), and/or 5^{th} Generation (5G).

As another example, the communication unit 110 may include at least one port for connecting to an external device via a cable to perform wired communication with the external device. For example, the communication unit 110 may include at least one of a High-Definition Multimedia Interface (HDMI) port, a component jack, a PC port, or a Universal Serial Bus (USB) port. Accordingly, the communication unit 110 may perform communication with an external device connected thereto in a wired manner through the at least one port. Here, the port may refer to a physical device component into which a cable, a communication line, or a plug may be connected or inserted.

As described above, the communication unit 110 may include at least one support element for supporting communication between the electronic device 100 and the external device. Here, the support element may include the aforementioned communication module, communication circuit, communication device, port (for input/output of data), cable port (for input/output of data), plug (for input/output of data), or the like. For example, examples of the at least one support element included in the communication unit 110 may include an Ethernet communication module, a Wi-Fi communication module, a Bluetooth communication module, an IR communication module, a USB port, a tuner (or a broadcast receiver), an HDMI port, a display port (DP), a digital visual interface (DVI) port, and the like.

The display 120 may output an image or data processed by the electronic device 100. Although FIG. 3 illustrates that the electronic device 100 includes the display 120, the disclosure is not limited thereto. The electronic device 100 may not include the display 120 or may include only a simple display for notification or the like. In this case, the electronic device 100 may output an image to a separate TV or monitor through a video/audio output port or the like. In addition, the electronic device 100 may output an image to a TV or monitor through wireless communication or the like.

The display 120 may display image content from various sources. For example, the display 120 may receive and display image content from various sources such as a tuner, HDMI, or OTT.

The memory 130 may store a program for the processor 140 to perform processing and control, and store data input to the electronic device 100 or output from the electronic device 100. In addition, the memory 130 may store data required for an operation of the electronic device 100.

The memory 130 may include at least one of flash memory, a hard disk, multimedia card micro memory, card type memory (e.g., Secure Digital (SD) or eXtreme Digital (XD) memory), random-access memory (RAM), static random-access memory (SRAM), read-only memory (ROM), electrically erasable programmable read-only memory (EEPROM), programmable read-only memory (PROM), magnetic memory, a magnetic disk, or an optical disk.

The processor 140 controls the overall operation of the electronic device 100. For example, the processor 140 may perform functions of the electronic device 100 described herein by executing one or more instructions stored in the memory 130.

The processor 140 may include various pieces of processing circuitry and/or a plurality of processors. For example, the term "processor" used herein, including in the claims, may include various pieces of processing circuitry including at least one processor. One or more processors in the at least one processor may be configured to perform various functions described herein individually and/or collectively in a distributed manner. As used herein, "processor," "at least one processor," and "one or more processors" may be configured to perform various functions. However, these terms cover, for example but not limited to, situations where one processor performs some of the functions and other processor(s) perform the other functions, and situations where a single processor may perform all of the functions. In addition, the at least one processor may include a combination of processors configured to perform various functions disclosed herein in a distributed manner. The at least one processor may execute program instructions to achieve or perform various functions.

According to an embodiment of the disclosure, the processor 140 may store one or more instructions in internally provided memory, and may execute the one or more instructions stored in the internally provided memory to perform control such that operations of a display device are performed. That is, the processor 140 may perform a certain operation by executing at least one instruction or program stored in internal memory provided inside the processor 140 or in the memory 130.

According to an embodiment of the disclosure, the processor 140 may perform an operation of the electronic device 100 disclosed herein by executing the one or more instructions stored in the memory 130.

According to an embodiment of the disclosure, by executing the one or more instructions stored in the memory 130, the processor 140 may obtain a feature corresponding to an object from at least one frame among frames corresponding to content, based on a neural network.

According to an embodiment of the disclosure, by executing the one or more instructions stored in the memory 130, the processor 140 may obtain, based on the obtained feature corresponding to the object, the object in another frame other than the frame from which the feature corresponding to the object is obtained.

According to an embodiment of the disclosure, by executing the one or more instructions stored in the memory 130, the processor 140 may perform image processing on the object or an image surrounding the object such that the object is distinguished in the other frame in which the object is obtained.

According to an embodiment of the disclosure, the feature corresponding to the object may include at least one of a position of the object, a color of the object, or a feature of a starting point of the object.

According to an embodiment of the disclosure, by executing the one or more instructions stored in the memory 130, the processor 140 may, in response to determining that the feature corresponding to the object is changed, obtain a feature corresponding to the changed object by using the neural network according to the determination.

According to an embodiment of the disclosure, by executing the one or more instructions stored in the memory 130, the processor 140 may, in response to the object not being obtained for a threshold time period or in response to identifying, based on content identification information, that the content is changed, determine that the feature corresponding to the object is changed.

According to an embodiment of the disclosure, by executing the one or more instructions stored in the memory 130, the processor 140 may process the object obtained based on the feature corresponding to the object to obtain a plurality of detailed features corresponding to the object.

According to an embodiment of the disclosure, by executing the one or more instructions stored in the memory 130, the processor 140 may process the object or an image surrounding the object, based on the plurality of detailed features corresponding to the object.

According to an embodiment of the disclosure, the plurality of detailed features corresponding to the object may include at least one of the position of the object, the feature of the starting point of the object, the color of the object, a color of a boundary of the object, a feature of a corner of the object, or a color gradient between the object and the background.

According to an embodiment of the disclosure, by executing the one or more instructions stored in the memory 130, the processor 140 may identify the boundary of the object based on an edge filter that identifies a variation value between the object and a background image.

According to an embodiment of the disclosure, by executing the one or more instructions stored in the memory 130, the processor 140 may, in response to the color of the object not being distinguished from a color of a background image surrounding the object, perform processing to change the color of the object.

According to an embodiment of the disclosure, by executing the one or more instructions stored in the memory 130, the processor 140 may, in response to the background image surrounding the object including another object that is not distinguished from the object, perform processing to change a texture corresponding to the background image.

The electronic device 100 may be any type of device including a processor and memory for performing functions. The electronic device 100 may be a stationary device or a portable device. For example, the electronic device 100 may be a device including a display and capable of displaying image content, video content, game content, graphic content, or the like. The electronic device 100 may include various types of electronic devices capable of receiving and outputting content, such as various smart devices including TVs such as network TVs, smart TVs, Internet TVs, web TVs, or internet protocol televisions (IPTVs), computers such as desktop computers, laptop computers, or tablet computers, smart phones, cellular phones, game players, music players, video players, medical equipment, or home appliances. The electronic device 100 may be referred to as a display device in that it receives and displays content and may also be referred to as a content receiving device, a sink device, an electronic device, a computing device, or the like.

The block diagram of FIG. 3 illustrates the electronic device 100 according to an embodiment of the disclosure. Each component of the block diagram may be integrated, added, or omitted according to specifications of the electronic device 100 actually implemented. For example, two or more components may be combined into one component, or one component may be subdivided into two or more components as needed. In addition, functions performed by each block are for describing embodiments of the disclosure, and its detailed operation or device does not limit the scope of the disclosure.

Although FIG. 3 illustrates that the electronic device 100 includes a display, the disclosure is not limited thereto. For example, the electronic device 100 may be a device capable of providing content to an external display device including a display. The content may include an image, video, audio, text, a game, an application, or the like, but is not limited thereto. For example, the electronic device 100 may include a set-top box (STB), a Blu-ray disc player, a digital versatile disc (DVD) player, a game console, a digital camera, a camcorder, a streaming device, a home theater, or the like. In this case, the electronic device 100 may be configured to be connected to an external display device through an input/output unit such as an HDMI port and transmit video/audio signals to the external display device. Alternatively, the electronic device 100 may be connected to an external display device through wired communication, or short-range wireless communication or long-range wireless communication such as wireless local area network (WLAN), Wi-Fi, or Bluetooth.

Hereinafter, the content providing server 200 will be described.

The content providing server 200 may include a communication unit 210, memory 220, and a processor 230. However, the content providing server 200 may be implemented by more components than the illustrated components and is not limited to the above-described example.

The communication unit 210 may include various pieces of communication circuitry included in one or more modules that enable wireless communication between the content providing server 200 and a wireless communication system or between the content providing server 200 and a network where another device is located. According to an embodiment of the disclosure, the communication unit 210 may perform communication with the electronic device 100 according to a short-range communication technology. The short-range communication technology may include, for example, Bluetooth communication, Wi-Fi communication, IR communication, or the like. The communication unit 210 may include at least one of a Bluetooth communication module, a Wi-Fi communication module, or an IR communication module.

The memory 220 may store a program for the processor 230 to perform processing and control, and store data input to the content providing server 200 or output from the content providing server 200.

The memory 220 may include at least one of flash memory, a hard disk, multimedia card micro memory, card type memory (e.g., SD or XD memory), RAM, SRAM, ROM, EEPROM, PROM, magnetic memory, a magnetic disk, or an optical disk.

The processor 230 is for controlling the overall operation of the content providing server 200 and may include various pieces of processing circuitry. For example, the processor 230 may perform functions of the content providing server 200 described herein by executing one or more instructions stored in the memory 220.

In an embodiment of the disclosure, the processor 230 may store one or more instructions in internally provided memory and may execute the one or more instructions stored in the internally provided memory to perform control such that the above-described operations are performed. That is, the processor 230 may perform a certain operation by executing at least one instruction or program stored in internal memory provided inside the processor 230 or in the memory 220.

According to an embodiment of the disclosure, by executing the one or more instructions stored in the memory 220, the processor 230 may control the communication unit 210 to establish a communication connection with the electronic device 100.

According to an embodiment of the disclosure, by executing the one or more instructions stored in the memory 220, the processor 230 may control the communication unit 210 to transmit content to the electronic device 100.

According to an embodiment of the disclosure, by executing the one or more instructions stored in the memory 220, the processor 230 may control the communication unit 210 to transmit information about a feature of an object in the content together when providing the content to the electronic device 100.

According to an embodiment of the disclosure, by executing the one or more instructions stored in the memory 220, the processor 230 may receive, from the electronic device 100, a request to detect a feature of an object included in the content.

According to an embodiment of the disclosure, by executing the one or more instructions stored in the memory 220, the processor 230 may detect the feature of the object from at least some frames of the content by using a DNN according to the object detection request received from the electronic device 100, and control the communication unit 210 to transmit the detected feature of the object to the electronic device 100.

The block diagram of FIG. 3 illustrates the content providing server 200 according to an embodiment of the disclosure. Each component of the block diagram may be integrated, added, or omitted according to specifications of the content providing server 200 actually implemented. For example, two or more components may be combined into one component, or one component may be subdivided into two or more components as needed. In addition, functions performed by each block are for describing embodiments of the disclosure, and its detailed operation or device does not limit the scope of the disclosure.

Hereinafter, the service server 300 will be described.

The service server 300 may include a communication unit 310, memory 320, and a processor 330. However, the service server 300 may be implemented by more components than the illustrated components and is not limited to the above-described example.

The communication unit 310 may include various communication circuits included in one or more modules that enable wireless communication between the service server 300 and a wireless communication system or between the service server 300 and a network where another device is located. According to an embodiment of the disclosure, the communication unit 310 may perform communication with the electronic device 100 according to an Internet protocol.

The memory 320 may store a program for the processor 330 to perform processing and control, and store data input to the service server 300 or output from the service server 300.

The memory 320 may include at least one of flash memory, a hard disk, multimedia card micro memory, card type memory (e.g., SD or XD memory), RAM, SRAM, ROM, EEPROM, PROM, magnetic memory, a magnetic disk, or an optical disk.

The processor 330 includes various pieces of processing circuitry for controlling the overall operation of the service server 300. For example, the processor 330 may perform functions of the service server 300 described herein by executing one or more instructions stored in the memory 320.

In an embodiment of the disclosure, the processor 330 may store one or more instructions in internally provided memory, and may execute the one or more instructions stored in the internally provided memory to perform control such that the above-described operations are performed. That is, the processor 330 may perform a certain operation by executing at least one instruction or program stored in internal memory provided inside the processor 330 or in the memory 320.

According to an embodiment of the disclosure, by executing the one or more instructions stored in the memory 320, the processor 330 may receive from the electronic device 100, a request to detect a feature of an object included in content.

According to an embodiment of the disclosure, by executing the one or more instructions stored in the memory 320, the processor 330 may detect the feature of the object from at least some frames of the content by using a DNN according to the object detection request received from the electronic device 100, and control the communication unit 310 to transmit the detected feature of the object to the electronic device 100.

The block diagram of FIG. 3 illustrates the service server 300 according to an embodiment of the disclosure. Each component of the block diagram may be integrated, added, or omitted according to specifications of the service server 300 actually implemented. For example, two or more components may be combined into one component, or one component may be subdivided into two or more components as needed. In addition, functions performed by each block are for describing embodiments of the disclosure, and its detailed operation or device does not limit the scope of the disclosure.

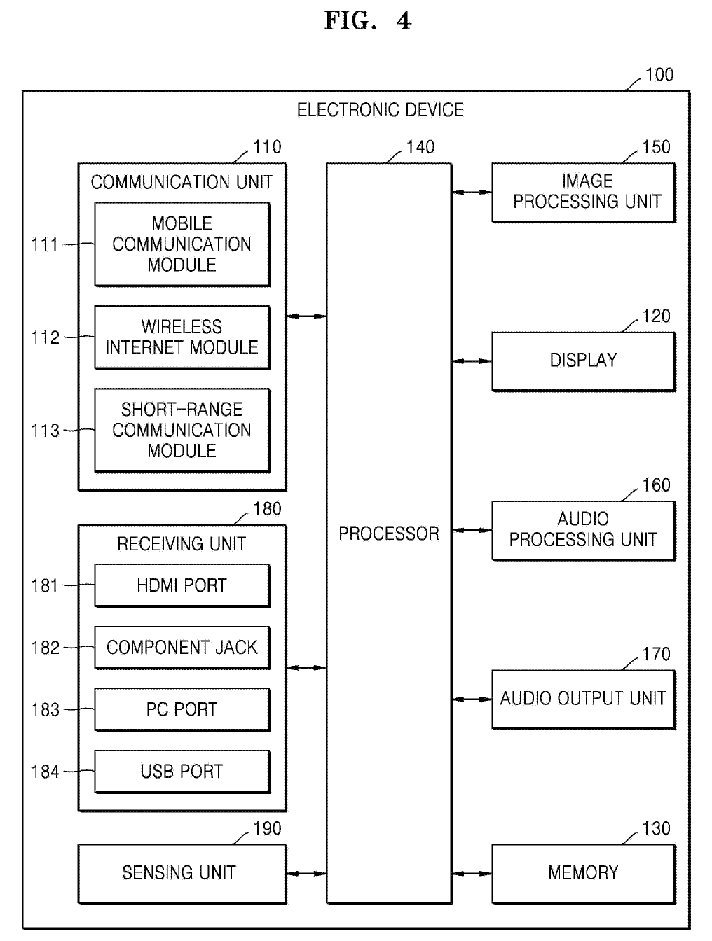

FIG. 4 is an example of a block diagram of an electronic device according to an embodiment of the disclosure.

Referring to FIG. 4, the electronic device 100 may include an image processing unit 150, an audio processing unit 160, an audio output unit 170, a receiving unit 180, and a sensing unit 190 in addition to the communication unit 110, the display 120, the memory 130, and the processor 140.

The communication unit 110 may include various pieces of communication circuitry included in one or more modules that enable wireless communication between the electronic device 100 and a wireless communication system or between the electronic device 100 and a network where another electronic device is located. For example, the communication unit 110 may include a mobile communication module 111, a wireless Internet module 112, and a short-range communication module 113.

The mobile communication module 111 transmits and receives radio signals to and from at least one of a base station, an external terminal, or a server on a mobile communication network. The radio signals may include a voice call signal, a video call signal, or various types of data according to text/multimedia message transmission and reception.

The wireless Internet module 112 refers to a module for wireless Internet access, and may be embedded in or external to a device. As a wireless Internet technology, WLAN (Wi-Fi), Wireless Broadband (Wibro), Worldwide Interoperability for Microwave Access (WiMAX), High Speed Downlink Packet Access (HSDPA), or the like may be used. Through the wireless Internet module 112, the device may establish a Wi-Fi peer-to-peer (P2P) connection with another device. The wireless Internet module 112 may be used to communicate with the service server 300.

The short-range communication module 113 refers to a module for short-range communication. As a short-range communication technology, Bluetooth, BLE, RFID, Infrared Data Association (IrDA), UWB, ZigBee, or the like may be used. The short-range communication module 113 may be used to communicate with the content providing server 200.

The display 120 may display, on a screen, an image signal received from the content providing server 200.

The memory 130 may store a program related to an operation of the electronic device 100 and various types of data generated during an operation of the electronic device 100.

The memory 130 may store at least one instruction. In addition, the memory 130 may store at least one instruction executable by the processor 140. In addition, the memory 130 may store at least one program executable by the processor 140. In addition, the memory 130 may store an application for providing a certain service.

In detail, the memory 130 may include at least one of flash memory, a hard disk, multimedia card micro memory, card type memory (e.g., SD or XD memory), RAM, SRAM, ROM, EEPROM, PROM, magnetic memory, a magnetic disk, or an optical disk.

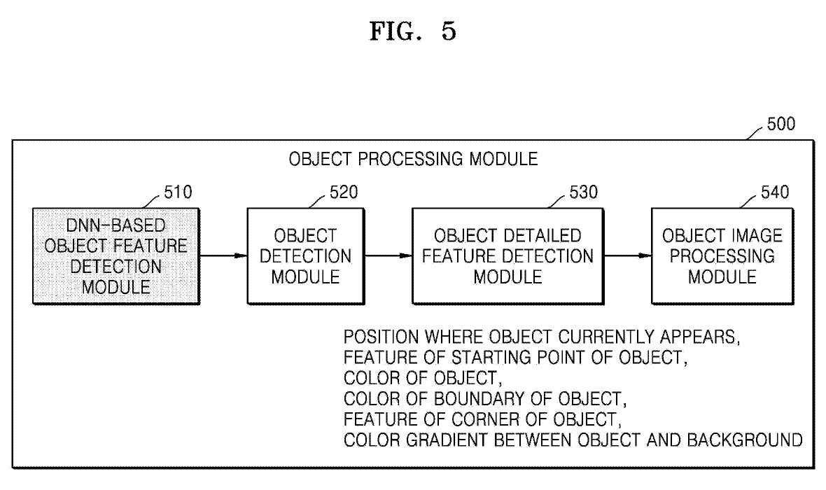

According to an embodiment of the disclosure, the memory 130 may include an object processing module 500 configured to process an object included in image content, according to embodiments of the disclosure. The object processing module 500 will be described in detail with reference to FIG. 5.

The processor 140 controls the overall operation of the electronic device 100. For example, the processor 140 may perform functions of the electronic device 100 described herein by executing one or more instructions stored in the memory 130.

The processor 140 may include various pieces of processing circuitry and/or a plurality of processors. For example, the term "processor" as used herein, including in the claims, may include various processing circuitries including at least one processor. One or more of the at least one processor may be configured to individually and/or collectively perform various functions described herein in a distributed manner. As used herein, "processor," "at least one processor," and "one or more processors" may be configured to perform various functions. However, these terms cover, for example but not limited to, situations where one processor performs some of the functions and other processor(s) perform the other functions, and situations where a single processor may perform all of the functions. In addition, the at least one processor may include a combination of processors configured to perform various functions disclosed herein in a distributed manner. The at least one processor may execute program instructions to achieve or perform various functions.

According to an embodiment of the disclosure, the processor 140 may store one or more instructions in internally provided memory, and may execute the one or more instructions stored in the internally provided memory to perform control such that operations of a display device are performed. That is, the processor 140 may perform a certain operation by executing at least one instruction or program stored in internal memory provided inside the processor 140 or in the memory 130.

Under control of the processor 140, the image processing unit 150 may process an image signal received from the receiving unit 180 or the communication unit 110, and output the processed image signal to the display 120. The image processing unit 150 may include various pieces of image processing circuitry.

Under control of the processor 140, the audio processing unit 160 may convert an audio signal received from the receiving unit 180 or the communication unit 110 into an analog audio signal, and output the analog audio signal to the audio output unit 170. The audio processing unit 160 may include various pieces of audio processing circuitry.

The audio output unit 170 may output audio (e.g., a voice or a sound) input through the communication unit 110 or the receiving unit 180. In addition, the audio output unit 170 may output audio stored in the memory 130 under control of the processor 140. The audio output unit 170 may include at least one of a speaker, a headphone output terminal, or a Sony/Philips Digital Interface (S/PDIF) output terminal, or a combination thereof.

The receiving unit 180 may receive video (e.g., a moving image), audio (e.g., a voice or music), additional information (e.g., an electronic program guide (EPG)), or the like from the outside of the electronic device 100, under control of the processor 140. The receiving unit 180 may include an HDMI port 181, a component jack 182, a PC port 183, a USB port 184, or a combination thereof. In addition to the HDMI port, the receiving unit 180 may further include a DisplayPort (DP), a Thunderbolt port, or a Mobile High-Definition Link (MHL) port. In addition, the receiving unit 180 may further include a port for separate output of a video signal and an audio signal.

The sensing unit 190 may detect a voice of a user, an image of the user, or an interaction of the user, and may include a microphone, a camera, and an optical receiver.

The microphone receives a voice uttered by the user. The microphone may convert the received voice into an electrical signal and output the electrical signal to the processor 140. User voices may include, for example, a voice corresponding to a menu or a function of the electronic device 100. Instead of being included in the electronic device 100 as described above, the microphone may be provided in a smart phone or a remote controller, and the electronic device 100 may receive, via Bluetooth communication or Wi-Fi communication, a voice signal that is received through the microphone of the smart phone or remote controller.

The camera may receive images (e.g., continuous frames) corresponding to a motion of the user including a gesture, within a camera recognition range. The processor 140 may select a menu to be displayed on the electronic device 100 or perform a control operation, based on a result of recognizing the received motion.

The optical receiver receives an optical signal (including a control signal) from a remote controller. The optical receiver may receive an optical signal corresponding to a user input (e.g., a touch, a press, a touch gesture, a voice, or a motion) from the remote controller. A control signal may be extracted from the received optical signal under control of the processor 140.

FIG. 5 illustrates an example of an object processing module according to an embodiment of the disclosure.

Referring to FIG. 5, the object processing module 500 may include a DNN-based object feature detection module 510, an object detection module 520, an object detailed feature detection module 530, and an object image processing module 540.

The DNN-based object feature detection module 510 may detect a feature of an object included in image content by using at least some frames of the image content as an input. The detected feature of the object may include a color of the object or a position of the object. For example, when the object includes a subtitle, the DNN-based object feature detection module 510 may detect a color of the subtitle or a position of the subtitle included in the image content.

The DNN-based object feature detection module 510 may obtain the feature of the object as an output by inputting at least some frames of the image content to a DNN model. Because the DNN-based object feature detection module 510 detects the feature of the object based on some frames rather than all frames of the image content, the electronic device 100 may save resources. In addition, the DNN-based object feature detection module 510 may reliably detect the feature of the object included in the image content by detecting the feature of the object based on several frames included in the image content or frames corresponding to a certain time period.

Although FIG. 5 illustrates that the object processing module 500 includes the DNN-based object feature detection module 510, the disclosure is not limited thereto. The DNN-based object feature detection module 510 may be included in a server instead of being included in the electronic device 100, and the electronic device 100 may request a feature of an object from the server.

According to an embodiment of the disclosure, the DNN-based object feature detection module 510 may be included in the content providing server 200. The electronic device 100 may request a feature of the object from the content providing server 200, and the content providing server 200 may detect the feature of the object in the image content by using the DNN-based object feature detection module 510 and provide the electronic device 100 with information about the feature of the object.

According to an embodiment of the disclosure, the DNN-based object feature detection module 510 may be included in the service server 300. The electronic device 100 may request a feature of the object from the service server 300, and the service server 300 may detect the feature of the object in the image content by using the DNN-based object feature detection module 510 and provide the electronic device 100 with information about the feature of the object.

The DNN-based object feature detection module 510 may provide the object detection module 520 with the information about the feature of the object in the image content.

The object detection module 520 may detect the object in frames of the image content based on the information about the feature of the object. For example, when the information about the feature of the object includes a color and a position of the object, the object detection module 520 may identify the position of the object in a frame of the image content and detect the object at the identified position of the object based on the color of the object.

The object detection module 520 may provide the detected object to the object detailed feature detection module 530.

The object detailed feature detection module 530 may detect detailed features of the object by analyzing the detected object. The detailed features of the object may include at least one of a position where the object currently appears in the frame of the image content, a feature of a starting point of the object, a color of the object, a color of a boundary of the object, a feature of a corner of the object, or a color gradient between the object and a background.

The object detailed feature detection module 530 may provide the object image processing module 540 with the detected detailed features of the object.

By using the detailed features of the object, the object image processing module 540 may perform image processing on the object or an object background image such that the object is clearly distinguished from the background image in the frame of the image content. The object background image may include an image surrounding the object. When the object background image has a color similar to the object, or when another object having a shape similar to the object exists in the object background image, the object may be difficult to distinguish from the object background image. Accordingly, the object image processing module 540 may perform image processing on the object and/or perform image processing on the object background image by using the detailed features of the object, to facilitate identification of the object.

According to an embodiment of the disclosure, the object image processing module 540 may apply an in-painting technique that changes the color of the object when the color of the object is similar to the color of the object background image, by using the detailed features of the object.

According to an embodiment of the disclosure, when a second object similar to the object exists in the object background image, the object image processing module 540 may apply the in-painting technique that analyzes a texture surrounding the second object and changes the second object to be similar to the texture surrounding the second object, by using the detailed features of the object.

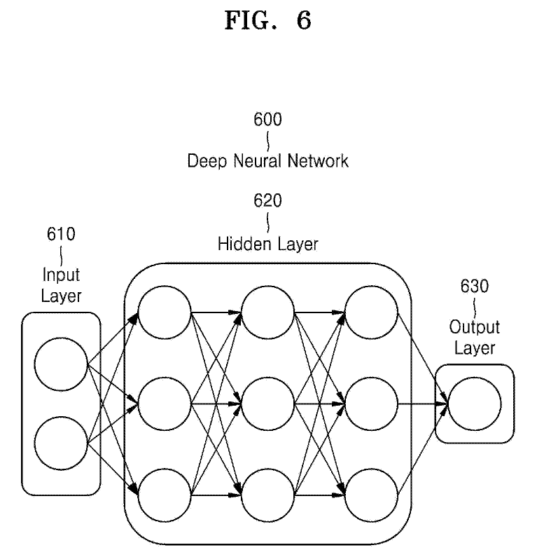

FIG. 6 illustrates an example of a DNN model according to an embodiment of the disclosure.

Referring to FIG. 6, a DNN 600 is an artificial neural network (ANN) including an input layer 610 where input data is input, an output layer 630 that outputs a final prediction result, and a plurality of hidden layers 620 arranged between the input layer 610 and the output layer 630 to process the input data and extract a feature. Similar to typical ANNs, the DNN 600 may model complex non-linear relationships. For example, in a DNN structure for an object identification model, each object may be represented as a hierarchical composition of basic elements of an image. In this case, additional layers may aggregate features of lower layers gathered gradually.

The DNN 600 is fundamentally an extension of the perceptron concept, where each node receives an input signal, multiplies the input signal by a weight, and generates an output signal through an activation function. Complex patterns of data are learned while passing through multiple layers. The activation function is for determining an output value of a neuron, and examples of the activation functions frequently used in DNNs include rectified linear unit (ReLU), sigmoid, Tanh, and the like.

Training of a DNN is performed through forward propagation and backward propagation. Forward propagation is a process of calculating an output through each layer based on input data, and a neuron of each layer receives an output of a previous layer, multiplies the output by a weight, applies an activation function, and delivers the result to a next layer. Backward propagation is a process of updating a weight by calculating an error between an output and a ground-truth value, and improves prediction performance of the model by adjusting the weight by calculating a gradient of the error.

Examples of algorithms applying the DNN include CNN, RNN, long short-term memory (LSTM), gated recurrent unit (GRU), and the like.

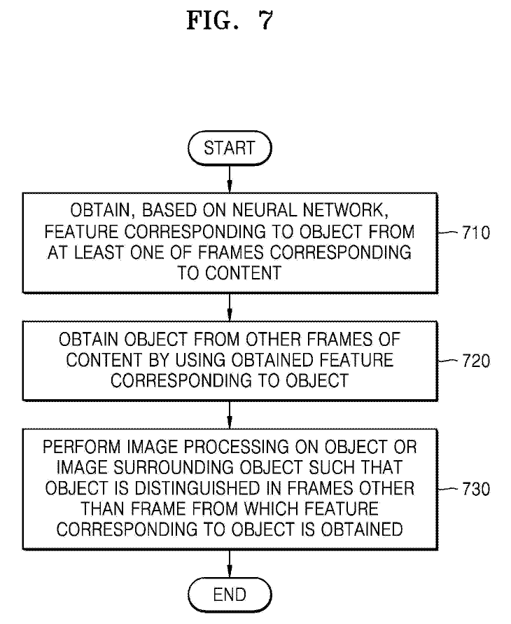

FIG. 7 illustrates an example of a method of operating an electronic device, according to an embodiment of the disclosure.

Referring to FIG. 7, in operation 710, the electronic device 100 may obtain, based on a neural network, a feature corresponding to an object from at least one frame among frames corresponding to content. The feature of the object may include at least one of a color or a position of the object.

According to an embodiment of the disclosure, the electronic device 100 may obtain the feature of the object from at least some frames of the content, based on a neural network model inside the electronic device 100.

According to an embodiment of the disclosure, the electronic device 100 may request a server including a neural network model, that is, the content providing server 200 or the service server 300, to detect the feature of the object from at least some frames of the content, and obtain the feature of the object by receiving information about the feature of the object from the server in response to the request.

According to an embodiment of the disclosure, when there is a pre-stored feature of the object for the content, the electronic device 100 may receive the feature of the object included in the content together with the content from the server. The server, for example, the content providing server 200 or the service server 300, may detect the feature of the object from some frames of the content by using a neural network, and store the detected feature as metadata for the content. Then, when there is a request from the electronic device 100, the server may provide the electronic device 100 with the metadata including the information about the feature of the object along with the content.

In operation 720, the electronic device 100 may detect the object in images of other frames of the content by using the obtained feature of the object.

According to an embodiment of the disclosure, when the feature of the object includes a color and a position of the object, the electronic device 100 may detect the object by detecting the corresponding color at the corresponding position in a frame of the content.

In operation 730, the electronic device 100 may perform image processing on the object or an image surrounding the object such that the object is distinguished in frames other than the frame from which the feature corresponding to the object is obtained.

According to an embodiment of the disclosure, when the object and an object background image have similar colors, the electronic device 100 may perform image processing to change the color of the object.

According to an embodiment of the disclosure, when a second object similar to the object exists in the object background image, the electronic device 100 may perform image processing to change a color or a pattern of the second object.

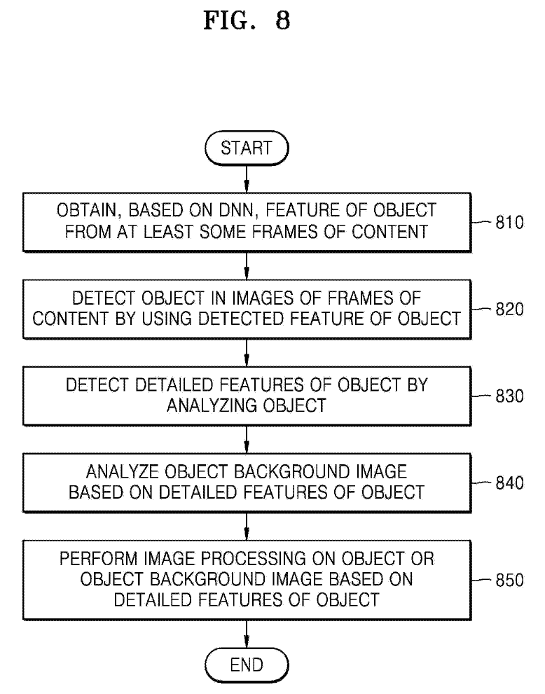

FIG. 8 is a flowchart illustrating processes of a method of operating the electronic device 100, according to an embodiment of the disclosure.

Referring to FIG. 8, in operation 810, the electronic device 100 may obtain, based on a DNN, a feature of an object from at least some frames of content. The feature of the object may include at least one of a color or a position of the object.

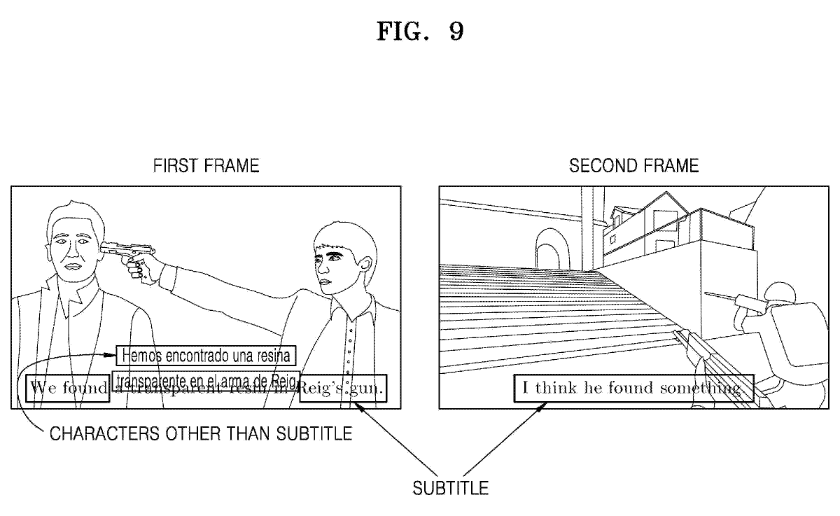

FIG. 9 illustrates examples of images including subtitles.

FIG. 9 illustrates a first frame and a second frame of the content. English subtitles are respectively displayed at lower center portions of the first frame and the second frame, and the first frame includes characters other than the subtitle, for example, Spanish characters, in addition to the subtitle.

By using a text detector to detect characters in an input image, a number of characters other than a subtitle may be detected. In the first frame of FIG. 9, although the main subtitle is the English subtitle, because the Spanish characters also correspond to a subtitle, both may inevitably be detected in the text detector or a subtitle detector.

Accordingly, according to an embodiment of the disclosure, it is possible to detect a feature of a subtitle by detecting the subtitle across multiple frames of the content through a DNN-based detector and identifying a subtitle that is continuously detected. For example, as illustrated in FIG. 9, the DNN-based detector may detect both an English subtitle portion and a Spanish subtitle portion in the first frame, but detect only the English subtitle in the second frame. Therefore, the DNN-based detector may determine, as a subtitle, characters commonly appearing across multiple frames, determine, as a position of the subtitle, a position of characters appearing in the second frame in FIG. 9, and determine the corresponding characters as the subtitle. From this, the DNN-based detector may detect the position and the color of the subtitle as the feature of the subtitle.

Because a process of detecting a feature of a subtitle as described above is performed by a DNN algorithm having a complex structure, it is difficult to continuously detect a main subtitle and perform post-processing in real time through this method in an on-device manner. Accordingly, when there is no feature of an already detected subtitle, this process is performed temporarily in an on-device manner or by a server, such that the subtitle may be effectively detected even in a low-specification TV.

As described above, when there is no pre-stored feature data of a subtitle in content, a feature of the subtitle may be detected by using a DNN model. When there is pre-stored feature data of a subtitle for image content, the feature data of the subtitle may be read and used.

The feature of the subtitle obtained in this way may be used until the subtitle cannot be detected by using the feature of the subtitle obtained in this way because a characteristic of the subtitle has changed.

That the characteristic of the subtitle has changed may be confirmed by verifying that the subtitle has not been detected for a predetermined time period or longer by using a previously obtained feature of the subtitle, or identifying, based on a schedule, that the program identifier (ID) has changed. When the characteristic of the subtitle has changed, the feature of the subtitle may be identified by performing DNN-based subtitle detection again. When it is difficult to perform the process of detecting the feature of the subtitle because the performance of the electronic device 100 is low, the server may detect the feature and transmit feature data of the subtitle to the electronic device 100.

According to an embodiment of the disclosure, the electronic device 100 may request and receive content from the content providing server 200, and in this case, when the content providing server 200 has a pre-stored feature of an object included in the content, the electronic device 100 may receive the feature of the object along with the content.

According to an embodiment of the disclosure, when the electronic device 100 is equipped with a DNN, the electronic device 100 may obtain the feature of the object included in the content by applying a DNN model to at least some frames of the content.

According to an embodiment of the disclosure, the electronic device 100 may request the content providing server 200 to detect the feature of the object of the content by using the DNN, and receive the feature of the object of the content from the content providing server 200 in response to the request.

According to an embodiment of the disclosure, the electronic device 100 may request the service server 300 to detect the feature of the object of the content by using the DNN, and receive the feature of the object of the content from the service server 300 in response to the request.

Referring back to FIG. 8, in operation 820, the electronic device 100 may detect the object in images of frames of the content by using the feature of the object detected based on the DNN.

According to an embodiment of the disclosure, when the feature of the object includes a color and a position of the object, the electronic device 100 may detect the object by detecting the corresponding color at the corresponding position in a frame of the content.

According to an embodiment of the disclosure, when the feature of the object includes a feature of a starting point of the object, the electronic device 100 may detect the object based on the feature of the starting point of the object in the content.

As described above, the electronic device 100 may detect the subtitle by using a simple image processing method based on at least one of the position of the object, the color of the object, or the feature of the starting point of the object.

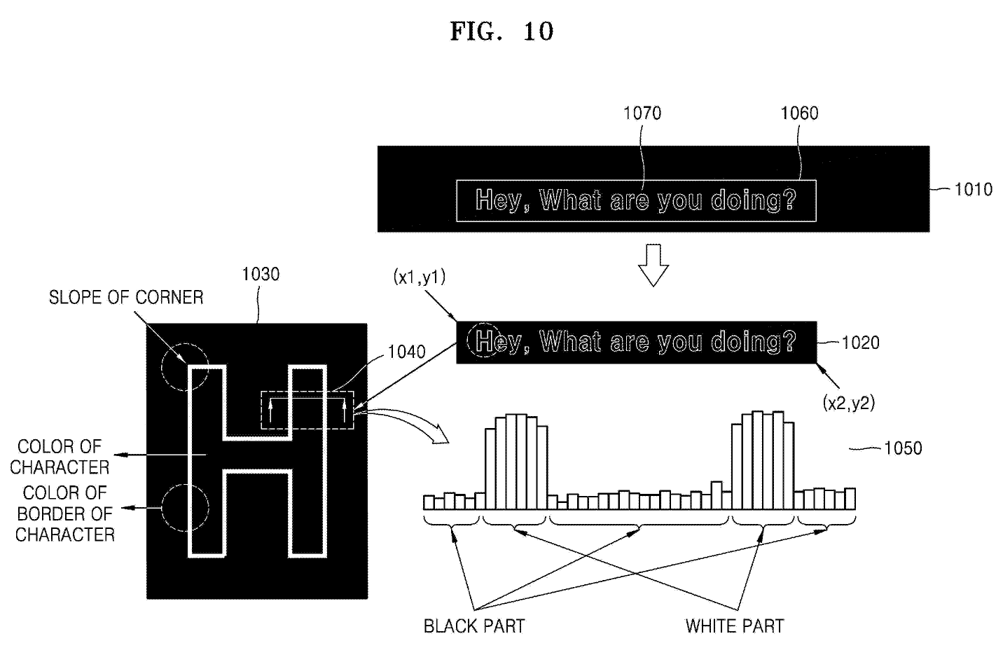

FIG. 10 is a reference diagram for describing an example of detecting a subtitle in an image including the subtitle, according to an embodiment of the disclosure.

Referring to FIG. 10, in an image 1010 including a subtitle 1020, the electronic device 100 may detect the subtitle 1020 by using a feature of the subtitle 1020, for example, that the subtitle 1020 is at a center portion of the image, the color of the border of the subtitle 1020 is white, and the color of the subtitle 1020 is black.

Referring back to FIG. 8, in operation 830, the electronic device 100 may detect detailed features of the detected object by analyzing the object. The detailed features of the object may be used to perform image processing such that the object is better distinguished from a background image.

The detailed features of the object may include more specific features of the object, including the feature of the object detected based on the DNN. The detailed features of the object may include at least one of a position where the object currently appears, a feature of a starting point of the object, a color of the object, a color of a boundary of the object, a feature of a corner of the object, or a color gradient between the object and a background.

Referring to FIG. 10, the detected detailed features of the subtitle 1020 may include at least one of a position where the subtitle 1020 currently appears, a feature of a starting point of the subtitle 1020, a color of the subtitle 1020, a color of a boundary of the subtitle 1020, a feature of a corner of the subtitle 1020, or a color gradient between the subtitle 1020 and a background.

A position where a subtitle currently appears may be represented by a start position of the first character and an end position of the last character of the subtitle. For example, in FIG. 10, the position may be represented by a start position (x1, y1) of the first character and an end position (x2, y2) of the last character of the subtitle 1020.

A feature of a starting point of a subtitle may include a particular character, number, symbol, or the like at a position where the subtitle starts, and in the subtitle 1020 illustrated in FIG. 10, it may be seen that there is no particular character, number, symbol, or the like at the starting position of the subtitle 1020.

A color of a subtitle refers to a color of characters of the subtitle.

A color of a boundary of a subtitle refers to a color of a border of a character of the subtitle.

A feature of a corner of a subtitle refers to a feature such as the slope of a corner of a character of the subtitle. In FIG. 10, a corner of a character of the subtitle has a right angle.

A color gradient between a subtitle and a background refers to a variation pattern of color values at a character border. An RGB value of black is (000, 000, 000), and an RGB value of white is (255, 255, 255). For example, referring to a color gradient 1050 for a right part 1040 of a character <H> 1030 among the characters of the subtitle 1020, a color value for a white part in the part 1040 indicates a high value, and a color value for a black part in the part 1040 indicates a low value.

Referring to FIG. 8, in operation 820, it is possible to detect the object in the image by using the detected feature of the object. Here, when it is difficult to distinguish the object from an object background image, the object may be detected by further referring to the detailed features of the object detected in operation 830.

The object background image may refer to an image surrounding the detected object. For example, in FIG. 10, in an image region 1060 including the subtitle 1020, the rest of the image excluding the subtitle 1020 or an image surrounding the subtitle 1020 may be an object background image. When a background having a color similar to the object 1020 exists in an object background image 1070, or when characters having similar colors overlap each other, it may be difficult to separate the object based only on the colors. As described above, when it is difficult to detect the object by using only the color of the object, the object may be separated by further referring to the detected detailed features of the object. By utilizing features, such as a color of a boundary, a corner, and a color gradient, as detailed features of the object, the boundary of the object 1020 may be more accurately identified in the object background image 1070.

According to an embodiment of the disclosure, the boundary of the object may be accurately identified by utilizing an edge detection filter technique that identifies a variation value between an object and an object background image. As described above, an edge detection filter may be used as a technique for identifying a boundary of an object. An edge refers to a part where intensity or color changes abruptly in an image. A method of identifying an edge is identifying a gradient of intensity by "differentiating" the image. The gradient is a vector having a direction and a magnitude, and represents a direction in which intensity changes (a direction of an edge) and a degree thereof. Examples of edge detection filters include a Laplacian filter, a Sobel filter, a Scharr filter, and the like.

As described above, an object may be detected in an image by using a feature of the object detected by a DNN, and detailed features of the object may be detected from the object detected in the image.

When there is a part in an image where it is difficult to distinguish the object, for example, when a color of an object background image is similar to the object or when another object exists in an object background image, the object may be more accurately detected by further using the detailed features of the object.

Referring back to FIG. 8, in operation 840, the electronic device 100 may analyze an object background image based on the detailed features of the object. The object background image may refer to an image surrounding the detected object. For example, in FIG. 10, in the image region 1060 including the subtitle 1020, the rest of the image excluding the subtitle 1020 or an image surrounding the subtitle 1020 may be an object background image. In order for the object to be well distinguished in the image, it may be desirable to cause the object background image 1070 and the object 1020 to be clearly distinguished from each other.

The electronic device 100 may analyze a feature of an object background image where an object is arranged, and identify whether there is a feature similar to a color of the object or a feature appearing like the object in the object background image. For example, when the color of characters of a subtitle is white, it is possible to determine whether an object background image is white or whether other subtitle characters exist in the object background image. Here, the other subtitle characters may refer to another subtitle or the like that is recognized as characters, although different from the subtitle detected by the electronic device 100 in operation 720. For example, when a subtitle is Spanish in original image content, and an English subtitle translated from the Spanish subtitle exists in image content currently displayed on the electronic device 100, the Spanish subtitle may appear behind the English subtitle to partially overlap it. In this case, the electronic device 100 may detect the Spanish subtitle characters in the object background image.

In operation 850, the electronic device 100 may perform image processing on the object or the object background image based on the detailed features of the object.

For example, when a result of analyzing the background image in operation 840 indicates that a color or shape similar to the object is included in the object background image, the electronic device 100 may perform image processing on the object or the object background image to improve visibility.

For example, when a color of the object is similar to a color of the object background image, the electronic device 100 may perform image processing to change the color of the object. For example, an in-painting technique may be used for such image processing. In-painting is a type of digital image processing, and may refer to a technique that restores a damaged image region or fills a deleted part.

For example, when another object exists in the object background image, the electronic device 100 may analyze a texture of another object background image to generate a pattern, and use an in-painting technique such that the other object is changed to be similar to the surrounding pattern. This process renders the other object included in the object background image invisible by creating an effect as if the other object has become transparent.

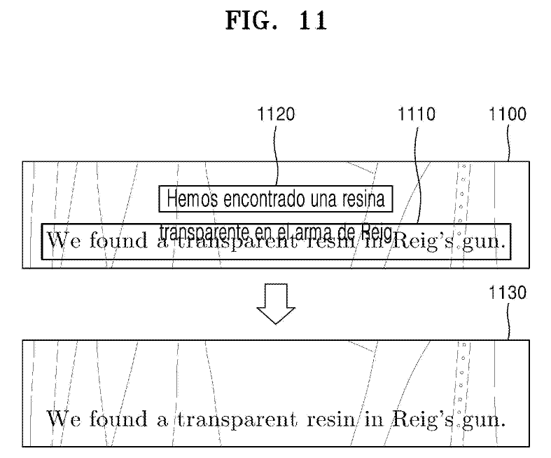

FIG. 11 is a reference diagram for describing an example of rendering other characters in an image surrounding a subtitle invisible by using an in-painting technique, according to an embodiment of the disclosure.

Referring to FIG. 11, there is a subtitle 1110 as a type of object, and other characters 1120 that are not the subtitle 1110 are displayed in an object background image 1100.

The electronic device 100 may analyze an image surrounding the characters 1120 in the object background image 1100 to identify a pattern of the image surrounding the characters 1120, and generate a pattern image according to the identified pattern. In addition, the electronic device 100 may obtain an image 1130 in which the characters 1120 of the object background image 1100 is invisible, by replacing a region where the characters 1120 are located in the object background image 1100, with the generated pattern image. The electronic device 100 may use an in-painting technique to perform image processing on a part of the object background image 1100 in this way.

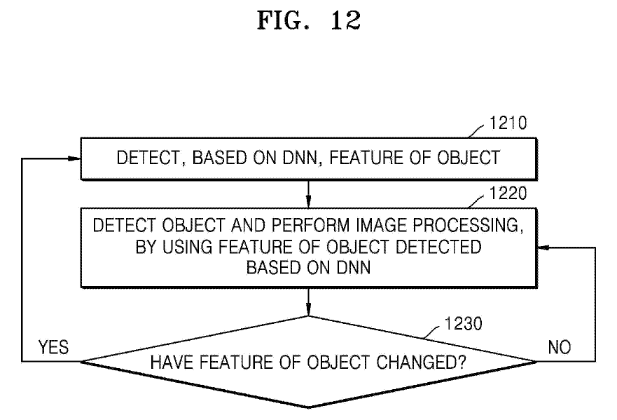

FIG. 12 is a flowchart illustrating processes of a method of operating an electronic device, according to an embodiment of the disclosure.

Referring to FIG. 12, in operation 1210, the electronic device 100 may detect, based on a DNN, a feature of an object in image content. Because the detecting of the feature of the object in the image content based on the DNN corresponds to operation 710 of FIG. 7 and operation 810 of FIG. 8, further description will be omitted.

In operation 1220, the electronic device 100 may detect the object and perform image processing, by using the feature of the object detected based on the DNN. Because operation 1220 corresponds to operations 720 and 730 of FIG. 7, and operations 820 to 850 of FIG. 8, further description will be omitted.

In operation 1230, the electronic device 100 may determine whether the feature of the object has changed.

According to an embodiment of the disclosure, the electronic device 100 detects the object by using the feature of the object detected based on the DNN, and when a time period during which the object is not detected is greater than a threshold time period, the electronic device 100 may determine that the feature of the object has changed.

According to an embodiment of the disclosure, when the content being displayed is changed, the electronic device 100 may determine that the feature of the object has changed. For example, the electronic device 100 may confirm that the content being displayed has changed, based on program information such as a program schedule. For example, in the case in which content identification information of currently displayed content is received as metadata, the electronic device 100 may confirm that the content has changed, based on the content identification information. For example, the electronic device 100 may confirm that the content has changed, by checking a channel number or program information on the displayed content screen via optical character recognition (OCR) or the like.

When a result of the determination in operation 1230 indicates that the feature of the object has not changed, the method may proceed to operation 1220 to continue detecting the object because it is possible to continue to detect the object based on the feature of the object detected in operation 1210.

When the result of the determination in operation 1230 indicates that the feature of the object has changed, the method may proceed to operation 1210 to newly detect a feature of the object based on the DNN because it is not possible to detect the object based on the feature of the object detected in operation 1210.

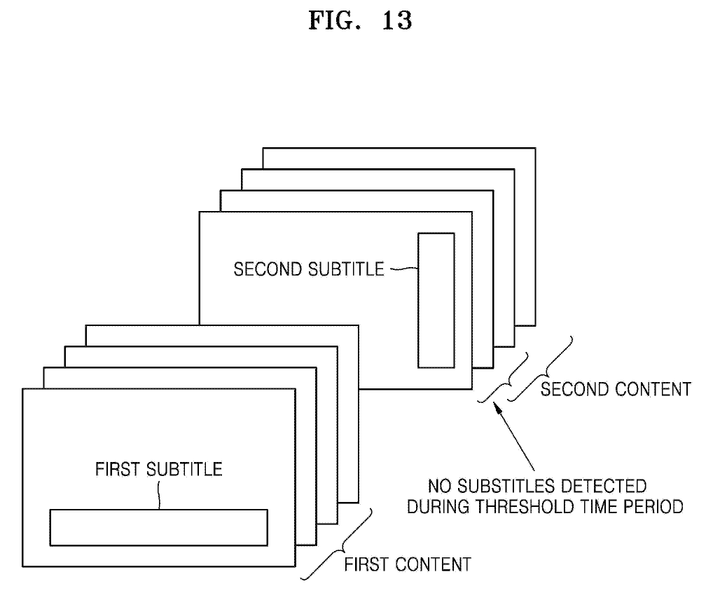

FIG. 13 is a reference diagram for describing an operation performed when content is changed, according to an embodiment of the disclosure.

Referring to FIG. 13, the electronic device 100 may initially display first content. The electronic device 100 may perform operations according to embodiments of the disclosure such that a display of a first subtitle included in the first content is clearly distinguished. The electronic device 100 may detect, based on a DNN, a feature of the first subtitle included in the first content, and detect the first subtitle based on the feature of the first subtitle.

As described above, when there is a content change while displaying the first content, the electronic device 100 may display second content.

In this case, because the position of subtitles may vary for each content, when attempting to detect a second subtitle in the second content based on the feature of the first subtitle, the electronic device 100 may fail to detect the second subtitle. That is, because the first subtitle is positioned at a lower center portion of an image whereas the second subtitle is positioned at a right center portion, the electronic device 100 may fail to detect the second subtitle based on the feature of the first subtitle. Accordingly, in this case, when the electronic device 100 has failed to detect a subtitle based on the feature of the first subtitle for a threshold time period, the electronic device 100 may newly detect a feature of a subtitle. That is, the electronic device 100 may newly obtain a feature of the second subtitle from some frames of the second content based on the DNN, and detect the second subtitle based on the newly obtained feature of the second subtitle.

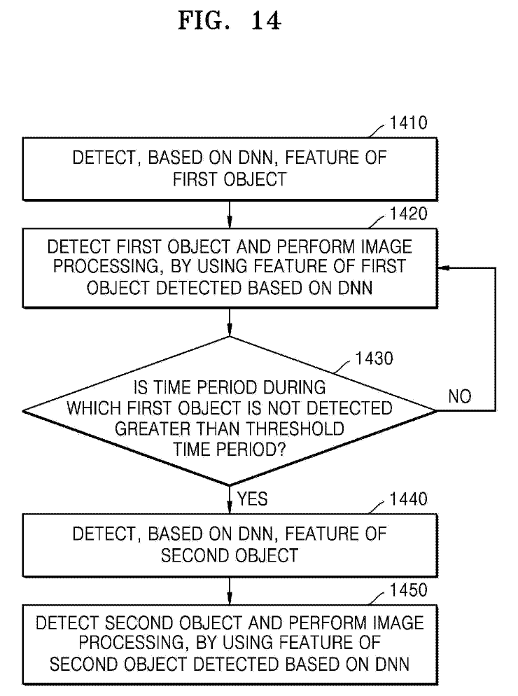

FIG. 14 is a flowchart illustrating processes of a method of operating an electronic device, according to an embodiment of the disclosure.

Referring to FIG. 14, in operation 1410, the electronic device 100 may detect, based on a DNN, a feature of a first object in image content. Because the detecting of the feature of the first object in the image content based on the DNN corresponds to operation 710 of FIG. 7 and operation 810 of FIG. 8, further description will be omitted.

In operation 1420, the electronic device 100 may detect the first object and perform image processing, by using the feature of the first object detected based on the DNN. Because operation 1420 corresponds to operations 720 and 730 of FIG. 7, and operations 820 to 850 of FIG. 8, further description will be omitted.

In operation 1430, the electronic device 100 may determine whether a time period during which the first object is not detected is greater than a threshold time period. For example, the electronic device 100 may determine whether a time period during which an object having the feature of the first object detected in operation 1410, for example, with the color of the first object and at the position of the first object, is not detected is greater than the threshold time period. For example, when there is a content change, the feature of the object may be changed. For example, when the content is not changed but the position or color of the object is changed, the feature of the object may be changed.

When a result of the determination in operation 1430 indicates that the time period during which the first object is not detected is not greater than the threshold time period, the method may proceed to operation 1420 to continue to detect the first object based on the feature of the first object.

When the result of the determination in operation 1430 indicates that the time period during which the first object is not detected is greater than the threshold time period, the method may proceed to operation 1440.

In operation 1440, the electronic device 100 may detect, based on the DNN, a feature of a second object. Because the detecting of the feature of the second object in the image content based on the DNN corresponds to operation 710 of FIG. 7 and operation 810 of FIG. 8, further description will be omitted.

In operation 1450, the electronic device 100 may detect the second object and perform image processing, by using the feature of the second object detected based on the DNN. Because operation 1450 corresponds to operations 720 and 730 of FIG. 7, and operations 820 to 850 of FIG. 8, further description will be omitted.

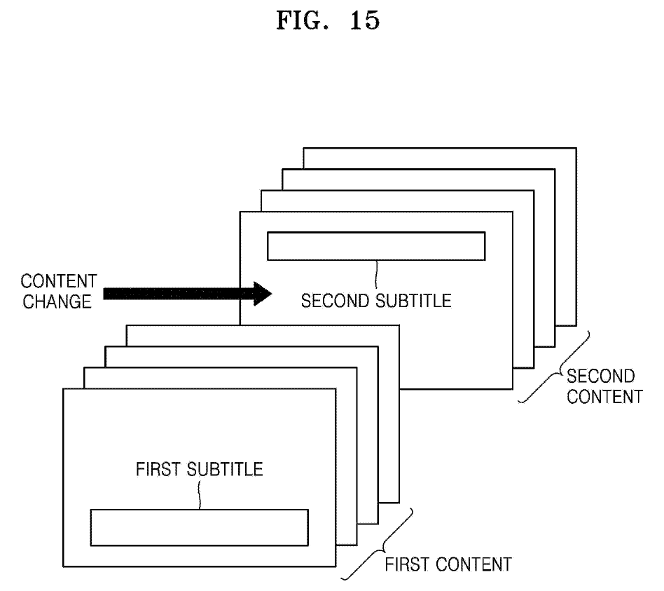

FIG. 15 is a reference diagram for describing an operation performed when content is changed, according to an embodiment of the disclosure.

Referring to FIG. 15, the electronic device 100 may initially display first content. The electronic device 100 may perform operations according to embodiments of the disclosure such that a display of a first subtitle included in the first content is clearly distinguished. The electronic device 100 may detect, based on a DNN, a feature of the first subtitle included in the first content, and detect the first subtitle based on the feature of the first subtitle.

As described above, when there is a content change while displaying the first content, the electronic device 100 may display second content. The electronic device 100 may confirm that the displayed content has changed. For example, the electronic device 100 may recognize that the displayed content has changed, by referring to program information containing information about broadcast content, by recognizing identification information of the displayed content from metadata, or by recognizing content information displayed on a content screen by using OCR, fingerprinting, or the like. As described above, because the position or features of subtitles may be changed when the displayed content is changed, the electronic device 100 may newly obtain a feature of a subtitle.

Accordingly, when it is determined that the content has changed, the electronic device 100 may newly detect a feature of a subtitle. That is, the electronic device 100 may newly obtain a feature of a second subtitle from some frames of the second content based on the DNN and detect the second subtitle based on the newly obtained feature of the second subtitle.

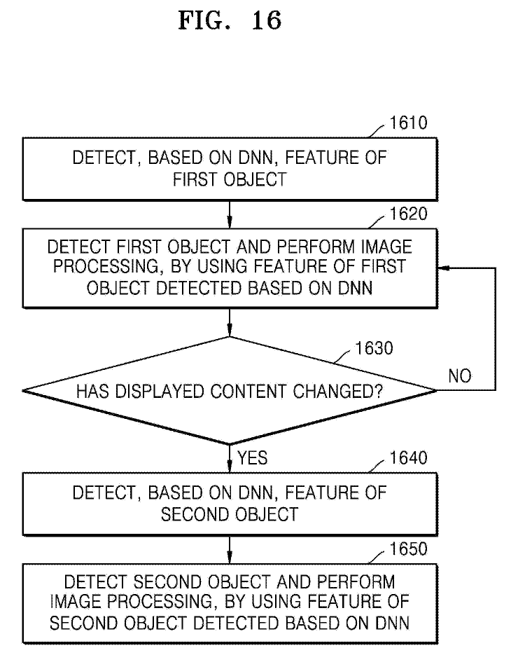

FIG. 16 is a flowchart illustrating processes of a method of operating an electronic device, according to an embodiment of the disclosure.

Referring to FIG. 16, in operation 1610, the electronic device 100 may detect, based on a DNN, a feature of a first object in image content. Because the detecting of the feature of the first object in the content based on the DNN corresponds to operation 710 of FIG. 7 and operation 810 of FIG. 8, further description will be omitted.

In operation 1620, the electronic device 100 may detect the first object and perform image processing, by using the feature of the first object detected based on the DNN. Because operation 1620 corresponds to operations 720 and 730 of FIG. 7, and operations 820 to 850 of FIG. 8, further description will be omitted.

In operation 1630, the electronic device 100 may determine whether the displayed content has changed.

According to an embodiment of the disclosure, the electronic device 100 may determine whether there is a change in the currently displayed content, by referring to program information containing information about broadcast content, for example, an EPG.

According to an embodiment of the disclosure, when receiving content from the content providing server 200, the electronic device 100 may also receive content identification information as metadata. Accordingly, when the content has changed, the electronic device 100 may determine whether the content has changed by comparing such content identification information.

According to an embodiment of the disclosure, the electronic device 100 may determine whether the content has changed by recognizing a content screen displayed on the display screen in real time. The electronic device 100 may obtain content identification information by capturing the content screen displayed on the display screen and recognizing characters, such as a channel number or a program ID, from the captured screen. The electronic device 100 may determine whether the content has changed based on whether image content identification information has changed.

When a result of the determination in operation 1630 indicates that the displayed content has not changed, the method may proceed to operation 1620 to continue to detect the first object based on the feature of the first object.

When the result of the determination in operation 1630 indicates that the displayed content has changed, the method may proceed to operation 1640.

In operation 1640, the electronic device 100 may detect, based on the DNN, a feature of a second object. Because the detecting of the feature of the second object in the content based on the DNN corresponds to operation 710 of FIG. 7 and operation 810 of FIG. 8, further description will be omitted.

In operation 1650, the electronic device 100 may detect the second object and perform image processing, by using the feature of the second object detected based on the DNN. Because operation 1650 corresponds to operations 720 and 730 of FIG. 7, and operations 820 to 850 of FIG. 8, further description will be omitted.

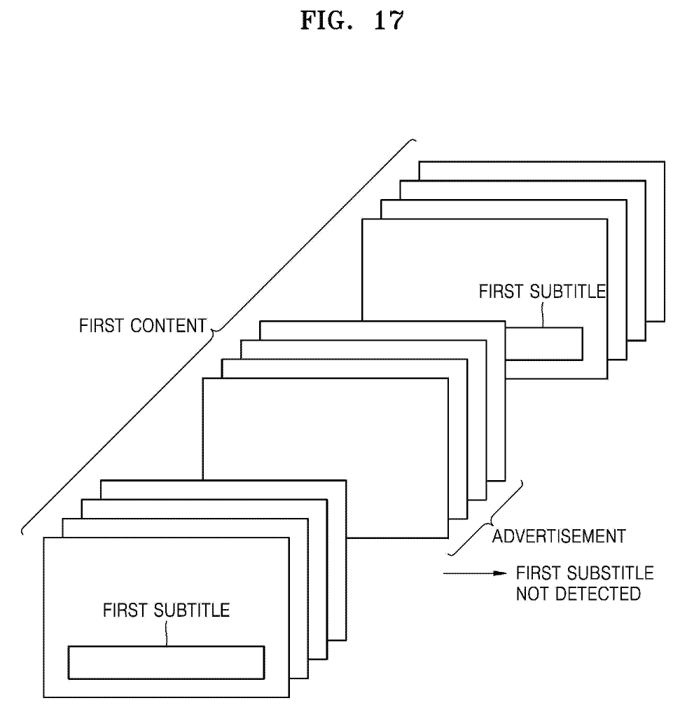

FIG. 17 is a reference diagram for describing an operation performed when content is not changed, according to an embodiment of the disclosure.

Referring to FIG. 17, the electronic device 100 may initially display first content. The electronic device 100 may perform operations according to embodiments of the disclosure such that a display of a first subtitle included in the first content is clearly distinguished. The electronic device 100 may detect, based on a DNN, a feature of the first subtitle included in the first content, and detect the first subtitle based on the feature of the first subtitle.

As described above, when an advertisement is displayed while displaying the first image content, the electronic device 100 may fail to detect the first subtitle based on the feature of the first subtitle while the advertisement is displayed. In this case, because the image content itself has not changed, the electronic device 100 may detect the first subtitle in the first image content based on the feature of the first subtitle again after the advertisement ends.

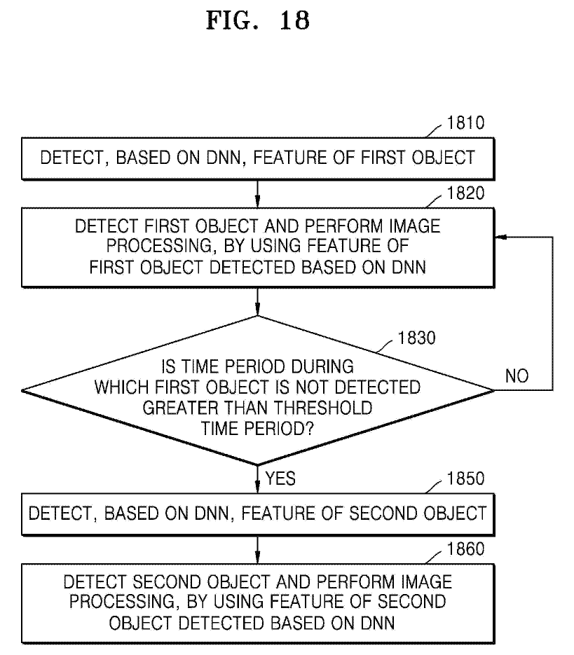

FIG. 18 is a flowchart illustrating processes of a method of operating an electronic device, according to an embodiment of the disclosure.

Referring to FIG. 18, in operation 1810, the electronic device 100 may detect, based on a DNN, a feature of a first object in content. Because the detecting of the feature of the first object in the content based on the DNN corresponds to operation 710 of FIG. 7 and operation 810 of FIG. 8, further description will be omitted.

In operation 1820, the electronic device 100 may detect the first object and perform image processing, by using the feature of the first object detected based on the DNN. Because operation 1820 corresponds to operations 720 and 730 of FIG. 7, and operations 820 to 850 of FIG. 8, further description will be omitted.

In operation 1830, the electronic device 100 may determine whether a time period during which the first object is not detected is greater than a threshold time period. For example, the electronic device 100 may determine whether a time period during which an object having the feature of the first object detected in operation 1810, for example, with the color of the first object and at the position of the first object, is not detected is greater than the threshold time period.

When a result of the determination in operation 1830 indicates that the time period during which the first object is not detected is not greater than the threshold time period, the method may proceed to operation 1820 to continue to detect the first object based on the feature of the first object.

When the result of the determination in operation 1830 indicates that the time period during which the first object is not detected is greater than the threshold time period, the method may proceed to operation 1840.

In operation 1840, the electronic device 100 may determine whether the content has changed. Because the determining of whether the content has changed corresponds to operation 1630 of FIG. 16, further description will be omitted.

When a result of the determination in operation 1840 indicates that the content has not changed, the method may proceed to operation 1820 to continue to detect the first object based on the feature of the first object. That is, in this case, the electronic device 100 may determine that video such as an advertisement is temporarily transmitted rather than the content being changed, and continue to detect the first object based on the feature of the first object.

When the result of the determination in operation 1840 indicates that the content has changed, the method may proceed to operation 1850.

In operation 1850, the electronic device 100 may detect, based on the DNN, a feature of a second object. Because the detecting of the feature of the second object in the image content based on the DNN corresponds to operation 710 of FIG. 7 and operation 810 of FIG. 8, further description will be omitted.

In operation 1860, the electronic device 100 may detect the second object and perform image processing, by using the feature of the second object detected based on the DNN. Because operation 1860 corresponds to operations 720 and 730 of FIG. 7, and operations 820 to 850 of FIG. 8, further description will be omitted.

According to an embodiment of the disclosure, an electronic device may include memory including one or more instructions, and at least one processor.

According to an embodiment of the disclosure, the at least one processor individually or collectively may execute the one or more instructions to cause the electronic device to obtain, based on a neural network, a feature corresponding to an object from at least one frame among frames corresponding to content.

According to an embodiment of the disclosure, the at least one processor individually or collectively may execute the one or more instructions to cause the electronic device to obtain, based on the obtained feature corresponding to the object, the object in another frame other than the frame from which the feature corresponding to the object is obtained.

According to an embodiment of the disclosure, the at least one processor individually or collectively may execute the one or more instructions to cause the electronic device to perform image processing on the object or an image surrounding the object such that the object is distinguished in the other frame in which the object is obtained.

According to an embodiment of the disclosure, the feature corresponding to the object may include at least one of a position of the object, a color of the object, or a feature of a starting point of the object.

According to an embodiment of the disclosure, the at least one processor individually or collectively may execute the one or more instructions to cause the electronic device to, in response to determining that the feature corresponding to the object is changed, obtain a feature corresponding to a changed object by using the neural network according to the determining.

According to an embodiment of the disclosure, the at least one processor individually or collectively may execute the one or more instructions to cause the electronic device to, in response to the object not being obtained for a threshold time period or in response to identifying, based on content identification information, that the content is changed, determine that the feature corresponding to the object is changed.

According to an embodiment of the disclosure, the at least one processor individually or collectively may execute the one or more instructions to cause the electronic device to obtain a plurality of detailed features corresponding to the object by processing the object obtained based on the feature corresponding to the object.

According to an embodiment of the disclosure, the at least one processor individually or collectively may execute the one or more instructions to cause the electronic device to process the object or the image surrounding the object based on the plurality of detailed features corresponding to the object.

According to an embodiment of the disclosure, the plurality of detailed features corresponding to the object may include at least one of a position of the object, a feature of a starting point of the object, a color of the object, a color of a boundary of the object, a feature of a corner of the object, or a color gradient between the object and a background.

According to an embodiment of the disclosure, the at least one processor individually or collectively may execute the one or more instructions to cause the electronic device to identify the boundary of the object based on an edge filter that identifies a variation value between the object and a background image.

According to an embodiment of the disclosure, the at least one processor individually or collectively may execute the one or more instructions to cause the electronic device to, in response to the color of the object not being distinguished from a color of the background image surrounding the object, perform processing to change the color of the object.

According to an embodiment of the disclosure, the at least one processor individually or collectively may execute the one or more instructions to cause the electronic device to, in response to the background image surrounding the object including another object that is not distinguished from the object, perform processing to change a texture corresponding to the background image.

According to an embodiment of the disclosure, a method of operating an electronic device may include obtaining, based on a neural network, a feature corresponding to an object from at least one frame among frames corresponding to content.

According to an embodiment of the disclosure, the method of operating the electronic device may include obtaining, based on the obtained feature corresponding to the object, the object in another frame other than the frame from which the feature corresponding to the object is obtained.

According to an embodiment of the disclosure, the method of operating the electronic device may include performing image processing on the object or an image surrounding the object such that the object is distinguished in the other frame in which the object is obtained.

According to an embodiment of the disclosure, in the method of operating the electronic device, the feature corresponding to the object may include at least one of a position of the object, a color of the object, or a feature of a starting point of the object.

According to an embodiment of the disclosure, the method of operating the electronic device may include, in response to determining that the feature corresponding to the object is changed, obtaining a feature corresponding to a changed object by using the neural network according to the determining.

According to an embodiment of the disclosure, the method of operating the electronic device may include, in response to the object not being obtained for a threshold time period or in response to identifying, based on content identification information, that the content is changed, determining that the feature corresponding to the object is changed.

According to an embodiment of the disclosure, the method of operating the electronic device may include obtaining a plurality of detailed features corresponding to the object by processing the object obtained based on the feature corresponding to the object.

According to an embodiment of the disclosure, the method of operating the electronic device may include processing the object or the image surrounding the object based on the plurality of detailed features corresponding to the object.

According to an embodiment of the disclosure, the plurality of detailed features corresponding to the object may include at least one of a position of the object, a feature of a starting point of the object, a color of the object, a color of a boundary of the object, a feature of a corner of the object, or a color gradient between the object and a background.

According to an embodiment of the disclosure, the method of operating the electronic device may include identifying the boundary of the object based on an edge filter that identifies a variation value between the object and a background image.

According to an embodiment of the disclosure, the method of operating the electronic device may include, in response to the color of the object not being distinguished from a color of the background image surrounding the object, performing processing to change the color of the object.

According to an embodiment of the disclosure, the method of operating the electronic device may include, in response to the background image surrounding the object including another object that is not distinguished from the object, performing processing to change a texture corresponding to the background image.

According to an embodiment of the disclosure, in a non-transitory computer-readable recording medium having stored therein one or more instructions executable by at least one processor of an electronic device, the one or more instructions, when executed by the at least one processor of the electronic device, may cause the electronic device to obtain, based on a neural network, a feature corresponding to an object from at least one frame among frames corresponding to content, obtain, based on the obtained feature corresponding to the object, the object in another frame other than the frame from which the feature corresponding to the object is obtained, and perform image processing on the object or an image surrounding the object such that the object is distinguished in the other frame in which the object is obtained.

Some embodiments of the disclosure may be implemented in the form of a recording medium including instructions executable by a computer such as a program module executable by a computer. The computer-readable medium may be any available medium which is accessible by a computer, and may include a volatile or non-volatile medium and a removable or non-removable medium. The computer-readable medium may also include a computer storage medium. The computer storage media include both volatile and non-volatile, removable and non-removable media implemented in any method or technique for storing information such as computer-readable instructions, data structures, program modules or other data.

Embodiments of the disclosure may be implemented by a software (S/W) program including instructions stored in a computer-readable storage medium.

The computer is a device capable of invoking instructions stored in a storage medium and performing operations according to embodiments of the disclosure, and may include an electronic device according to embodiments of the disclosure.

The computer-readable storage medium may be provided in the form of a non-transitory storage medium. Here, the term 'non-transitory' simply means that the storage medium is a tangible device, and does not include a signal, but this term does not differentiate between where data is semi-permanently stored in the storage medium and where the data is temporarily stored in the storage medium.

In addition, a control method according to embodiments of the disclosure may be provided in a computer program product. The computer program product may be traded as a commodity between sellers and buyers.

The computer program product may include a software (S/W) program and a computer-readable recording medium storing the S/W program. For example, the computer program product may include a product in the form of a S/W program electronically distributed (e.g., a downloadable application) through a manufacturer of a device or an electronic market (e.g., Google Play Store, App Store). For electronic distribution, at least part of the S/W program may be stored in a storage medium or temporarily generated. In this case, the storage medium may be a storage medium of a server of the manufacturer or a server of the electronic market, or a relay server that temporarily stores the S/W program.

The computer program product may include a storage medium of a server or a storage medium of a device, in a system consisting of the server and the device. Alternatively, when there is a third device (e.g., a smart phone) communicatively connected to the server or the device, the computer program product may include a storage medium of the third device. Alternatively, the computer program product may include an S/W program itself that is transmitted from the server to the device or the third device, or transmitted from the third device to the device.

In this case, any one of the server, the device, and the third device may execute the computer program product and perform the method according to embodiments of the disclosure. Alternatively, two or more of the server, the device, and the third device may execute the computer program product and perform the method according to embodiments of the disclosure in a distributed manner.

For example, the server (e.g., a cloud server or an artificial intelligence server) may execute the computer program product stored in the server, and may control the device communicatively connected to the server to perform the method according to embodiments of the disclosure.

As another example, the third device may execute the computer program product to control a device communicatively connected to the third device to perform the method according to an embodiment of the disclosure. When the third device executes the computer program product, the third device may download the computer program product from the server, and execute the downloaded computer program product. Alternatively, the third device may execute the computer program product provided in a preloaded state, and perform the method according to embodiments of the disclosure.

In addition, as used herein, terms such as "...er (or)", "... unit", "... module", etc., denote a unit that performs at least one function or operation, which may be implemented as H/W or S/W or a combination thereof.

The above descriptions of the disclosure are provided only for illustrative purposes, and those of skill in the art will understand that the disclosure may be easily modified into other detailed configurations without modifying technical aspects and essential features of the disclosure. Therefore, it should be understood that the above-described embodiments of the disclosure are exemplary in all respects and do not limit the scope of the disclosure. For example, each component described as being unitary may also be implemented in a distributed manner, and similarly, components described as being distributed may be implemented in a combined form.

The scope of the disclosure is not defined by the detailed description of the disclosure but by the following claims, and all modifications or alternatives derived from the scope and spirit of the claims and equivalents thereof fall within the scope of the disclosure.

1. An electronic device, comprising:
memory to store one or more instructions; and
at least one processor, individually or collectively executes the one or more instructions to cause the electronic device to:
obtain, based on a neural network, a feature corresponding to an object from at least one frame among frames corresponding to content,
detect, based on the obtained feature corresponding to the object, the object in another frame among the frames corresponding to content other than the at least one frame from which the feature corresponding to the object is obtained, and
perform an image processing on the object or an image surrounding the object such that the object is distinguished in the other frame in which the object is obtained.

2. The electronic device of claim 1, wherein the feature corresponding to the object includes at least one of a position of the object, a color of the object, or a feature of a starting point of the object.

3. The electronic device of claim 1, wherein the at least one processor individually or collectively executes the one or more instructions to cause the electronic device to:
determining whether the feature corresponding to the object is changed, and
based on the feature corresponding to the object being determined as changed, obtain a changed feature corresponding to the object by using the neural network.

4. The electronic device of claim 1, wherein the at least one processor individually or collectively executes the one or more instructions to cause the electronic device to:
determining whether the feature corresponding to the object is obtained within a threshold time period, and
based on the object not being obtained for the threshold time period or based on identifying, based on content identification information, that the content is changed, determine that the feature corresponding to the object is changed.

5. The electronic device of claim 1, wherein the at least one processor individually or collectively executes the one or more instructions to cause the electronic device to:
obtain a plurality of detailed features corresponding to the object by processing the object obtained based on the feature corresponding to the object, and process the object or the image surrounding the object based on the plurality of detailed features corresponding to the object.

6. The electronic device of claim 5, wherein the plurality of detailed features corresponding to the object include at least one of a position of the object, a feature of a starting point of the object, a color of the object, a color of a boundary of the object, a feature of a corner of the object, or a color gradient between the object and a background of the object.

7. The electronic device of claim 6, wherein the at least one processor individually or collectively executes the one or more instructions to cause the electronic device to:
identify the boundary of the object based on an edge filter that identifies a variation value between the object and a background image surrounding the object.

8. The electronic device of claim 7, wherein the at least one processor individually or collectively executes the one or more instructions to cause the electronic device to:
based on the color of the object not being distinguished from a color of the background image surrounding the object, perform the image processing to change the color of the object.

9. The electronic device of claim 8, wherein the at least one processor individually or collectively executes the one or more instructions to cause the electronic device to:
based on the background image surrounding the object including another object that is not distinguished from the object, perform the image processing to change a texture corresponding to the background image.

10. A method of operating an electronic device, the method comprising:
obtaining, based on a neural network, a feature corresponding to an object from at least one frame among frames corresponding to content;
detecting, based on the obtained feature corresponding to the object, the object in another frame among the frames corresponding to content other than the at least one frame from which the feature corresponding to the object is obtained; and
performing an image processing on the object or an image surrounding the object such that the object is distinguished in the other frame in which the object is obtained.

11. The method of claim 10, wherein the feature corresponding to the object includes at least one of a position of the object, a color of the object, or a feature of a starting point of the object.

12. The method of claim 10, further comprising:
determining whether the feature corresponding to the object is changed, and
based on the feature corresponding to the object being determined as changed, obtaining a changed feature corresponding to the object by using the neural network.

13. The method of claim 10, further comprising:
determining whether the feature corresponding to the object is obtained within a threshold time period, and
based on the object not being obtained for the threshold time period or based on identifying, based on content identification information, that the content is changed, determining that the feature corresponding to the object is changed.

14. The method of claim 10, further comprising:
obtaining a plurality of detailed features corresponding to the object by processing the object obtained based on the feature corresponding to the object; and
processing the object or the image surrounding the object based on the plurality of detailed features corresponding to the object.

15. The method of claim 14, wherein the plurality of detailed features corresponding to the object include at least one of a position of the object, a feature of a starting point of the object, a color of the object, a color of a boundary of the object, a feature of a corner of the object, or a color gradient between the object and a background of the object.

16. The method of claim 15, further comprising identifying the boundary of the object based on an edge filter that identifies a variation value between the object and a background image surrounding the object.

17. The method of claim 16, further comprising: based on the color of the object not being distinguished from a color of the background image surrounding the object, performing processing to change the color of the object.

18. The method of claim 17, further comprising:
based on the background image surrounding the object including another object that is not distinguished from the object, performing processing to change a texture corresponding to the background image.

19. A non-transitory computer-readable recording medium having stored therein one or more instructions executable by at least one processor of an electronic device to cause the electronic device to:
obtain, based on a neural network, a feature corresponding to an object from at least one frame among frames corresponding to content,
detect, based on the obtained feature corresponding to the object, the object in another frame among the frames corresponding to content other than the at least one frame from which the feature corresponding to the object is obtained, and
perform an image processing on the object or an image surrounding the object such that the object is distinguished in the other frame in which the object is obtained.

20. The non-transitory computer-readable recording medium of claim 19, wherein the one or more instructions, when executed by the at least one processor of the electronic device, cause the electronic device to:
determining whether the feature corresponding to the object is changed, and
based on the feature corresponding to the object being determined as changed, obtain a changed feature corresponding to the object by using the neural network.
